(19) United States
(12) Patent Application Publication
(10) Pub. No.: US 2011/0203021 A1
(43) Pub. Date: Aug. 18, 2011

(54) SPM NANOPROBES AND THE PREPARATION METHOD THEREOF

(75) Inventors: Sang Jung An, Daejeon (KR); Buong Chon Park, Daejeon (KR); Yung-ho Kahng, Seoul (KR); Jin Ho Choi, Incheon (KR); Kwang Hoon Jeong, Chungcheong-buk-do (KR)

(73) Assignee: KOREA RESEARCH INSTITUTE OF STANDARDS AND SCIENCE, Daejeon (KR)

(21) Appl. No.: 13/122,682

(22) PCT Filed: Jul. 31, 2009
(86) PCT No.: PCT/KR2009/004300

§ 371 Date: Apr. 5, 2011

(30) Foreign Application Priority Data
Aug. 1, 2008 (KR) 10-2008-0075397

(51) Int. Cl. G01Q 70/12; G01Q 70/16; B82Y 99/00; B82Y 15/00

(52) U.S. Cl. 850/58; 850/60; 977/773; 977/953

(57) ABSTRACT

The present invention relates to SPM nanoprobes and the preparation method thereof, more particularly, to SPM nanoprobes comprising a spheroid deposit capped-nanoneedle bonded to one end of a mother tip, wherein the spheroid deposit is formed by particle beam induced deposition and is characterized in that the ratio of the diameter of the spheroid deposit to that of the nanoneedle is in the range of 1.5 to 8.5. The SPM nanoprobe according to the present invention is capable of imaging or measuring an irregularly curved or complicated surface, pattern and/or a frictional or adhesive force thereof and controlling size of a spheroid deposit formed at the end portion of nanoneedle and the ratio of the diameter of the spheroid deposit to that of the nanoneedle arbitrarily.

### TECHNICAL FIELD

The present invention relates to a SPM nanoprobe and the preparation method thereof, more particularly, to a SPM nanoprobe comprising a spheroid deposit capped-nanoneedle bonded to one end of a mother tip, wherein the spheroid deposit is formed by particle beam induced deposition and is characterized in that the ratio of the diameter of the spheroid deposit to that of the nanoneedle is in the range of 1.5 to 8.5 and the preparation method thereof.

### BACKGROUND ART

SPMs (scanning probe microscopes) including AFM (Atomic Force Microscope), MFM (Magnetic force microscope), EFM (electrostatic force microscope), SNOM (scanning near field optical microscope) and LFM (lateral force microscope) are very powerful and useful apparatus in the nano technology. The resolution of SPM is known as atomic scale, however, in order to improve the resolution of SPM, the process of sharpening of the end of probe or tip is required. However, the conventional process of sharpening of the end of probe or tip like semiconductor micromachining had the limitation for improving the aspect ratio of the probe. Therefore, nanoneedles including carbon nanotube (CNT) are nominated as a new alternative for SPM probes. Because carbon nanotube has high aspect ratio as well as excellent electric and mechanical characteristics, there has been many trials on bonding carbon nanotubes to the end of the conventional SPM probes (mother tip) and getting images using the carbon nanotube tipped probes. U.S. Pat. Nos. 6,528,785 and 6,759,653 describe the method of bonding carbon nanotubes to mother tip using coating layer and method of arbitrarily cutting the nanotubes bonded to the mother tip using focused ion beam, respectively.

There are some important technical factors in adapting nanoneedles bonding to the SPM probe tips, for example the bonding strength of the nanoneedles to mother tips, length control of nanoneedles attached to mother tip and the direction and shape of the nanoneedles etc., regardless of the mother tip's shape. Though the above mentioned US patents are satisfactory to the first and second factors, they cannot satisfy the third condition. Moreover, it is impossible to get imaging the irregularly curved surface with the straight shaped CNT tipped probes.

There are some attempts to solve the above problem. CD-SPM (critical dimension SPM) is one of the results for solving the problem. The present inventors had shown the noble nanoneedle probes for CD-SPM prepared by the process comprising the steps of D) aligning a tip bonding a nanoneedle in the direction of ion beam radiation and D) radiate ion beam to the end of the tip (Korean Patent No. 697619), and the method for bending nano material including nanoneedle by radiating the particle beam (Korean Patent No. 767994).

However, the conventional probes for CD-SPM including those described in the above mentioned documents are inadequate for imaging or measuring frictional and/or adhesive force of the complicated inner space of analyte like bio cell or tissue. Therefore, a SPM nanoneedle probes having well defined end portion, for example an electrically conductive metal spheroid, is required. There may be two way for forming a ball shaped portion at the end of the nanoneedle. It is first that bonding the ready-made nano-sized electrically conductive ball to the end of the mother tip. However, it may be difficult to make the specified ball and to bonding it to the end of the nanoneedle at accurate position and direction. Meanwhile, the present inventors had reported a novel Pt ball-capped nanoprobes and the preparation method thereof (Park BC, Choi J H, Ahn S J, Kim D -H, Joon L, Dixon R, Orji G, Fu J, and Vorburger T, Proc. Of SPIE, 2007, 6518, 65819). However, the diameter of the Pt ball is no more than 60 nm and the the ratio of the diameter of the Pt ball to that of the nanoneedle is only under 1.4, so that the Pt ball capped nanoprobes described in the above document has the limitation in various use.

### DISCLOSURE OF INVENTION

### Technical Problem

Therefore, an object of the present invention is to provide SPM nanoprobes capable of imaging or measuring a irregularly curved or complicated surface, pattern and/or a frictional or adhesive force thereof and controlling size of a spheroid deposit formed at the end portion of nanoneedle and the ratio of the diameter of the spheroid deposit to that of the nanoneedle arbitrarily.

Another object of the present invention is to provide a preparation method said SPM nanoprobes.

### Solution to Problem

In order to achieve these objects, the present invention provides SPM nanoprobes comprising spheroid deposit capped-nanoneedle bonded to one end of the mother tip, wherein the spheroid deposit is formed by particle beam induced deposition and is characterized in that the ratio of the diameter of the spheroid deposit to that of the nanoneedle is in the range of 1.5 to 8.5.

Further, the present invention provides SPM nanoprobes, wherein the diameter of spheroid deposit is in the range of 15 to 1,000 nm.

Further, the present invention provides SPM nanoprobes, wherein the particle beam induced deposition is performed under the condition of the particle acceleration voltage in the range of 5 to 50 KeV and the particle density in the range of 400 to 10,000 particle/nm².

Further, the present invention provides SPM nanoprobes, wherein the particle beam is at least one selected from the group consisting of electron beam, neutron beam, proton beam, neutral atom beam and ion beam.

Further, the present invention provides SPM nanoprobes, wherein the neutral atom or ion is at least one atom or ion selected from the group consisting of He, B, Ne, Mg, Al, Si, P, Cl, Ar, Ti, Cr, Ga, Ge, Kr, In, Xe, Au and Pt.

Further, the present invention provides SPM nanoprobes, wherein the spheroid deposit is made of metal, carbon or the mixture thereof.

Furthermore, the present invention provides SPM nanoprobes, wherein the ratio (y/x) of the diameter of the spheroid deposit (y) to that of the nanoneedle (x) is in the range of 2 to 8, and the diameter of spheroid deposit is in the range of 80 to 600 nm.

According to another aspect of the present invention, the present invention provides a preparation method for SPM nanoprobe comprising the steps of; D. bonding a nanoneedle to the end portion of a mother tip, D. positioning said nanoneedle bonded-mother tip in a chamber, D. forming a spheroid deposit at the end portion of the nanoneedle by radiating particle beam to the end portion of the nanoneedle under the condition of the particle acceleration voltage in the range of 5 to 50 KeV and the particle density in the range of 400 to 10,000 particle/nm², wherein the the ratio (y/x) of the diameter of the spheroid deposit (y) to that of the nanoneedle (x) is in the range of 1.5 to 8.5.

Furthermore, the present invention provides a preparation method for SPM nanoprobe, wherein the diameter of spheroid deposit is in the range of 15 to 1,000 nm.

Furthermore, the present invention provides a preparation method for SPM nanoprobe, wherein the particle beam is at least one selected from the group consisting of electron beam, neutron beam, proton beam, neutral atom beam and ion beam.

Furthermore, the present invention provides a preparation method for SPM nanoprobe, wherein the neutral atom or ion is at least one atom or ion selected from the group consisting of He, B, Ne, Mg, Al, Si, P, Cl, Ar, Ti, Cr, Ga, Ge, Kr, In, Xe, Au and Pt.

Furthermore, the present invention provides a preparation method for SPM nanoprobe, wherein the spheroid deposit is made of metal, carbon or the mixture thereof.

Furthermore, the present invention provides a preparation method for SPM nanoprobe, wherein the ratio (y/x) of the diameter of the spheroid deposit (y) to that of the nanoneedle (x) is in the range of 2 to 8, and the diameter of spheroid deposit is in the range of 80 to 600 nm.

### Advantageous Effects of Invention

A SPM nanoprobe according to the present invention is capable of imaging or measuring a irregularly curved or complicated surface, pattern and/or a frictional or adhesive force thereof and controlling size of a spheroid deposit formed at the end portion of nanoneedle and the ratio of the diameter of the spheroid deposit to that of the nanoneedle arbitrarily.

### BRIEF DESCRIPTION OF DRAWINGS

FIG. 1 is a illustration for preparation process of SPM nanoprobe of the present invention

FIG. 2 is illustrative cross sectional view of SPM nanoprobe of the present invention

FIG. 3 is SEM images of Pt ball growth at the free-end of MWNT tip. After MWNT tip was aligned by ion beam (a). Pt was deposited in steps with the cumulative target thicknesses: (b) 20 nm, (c) 30 nm, (d) 40 nm, (e) 60 nm, (f) 120 nm, (g)190 nm, (h) 340 nm, and (i) 400 nm.

FIG. 4 is TEM images of Pt ball tips. Pt deposition target thicknesses were: (a) 10 nm, and (b) 30 nm.

FIG. 5 is EDS results at various spots on a Pt ball tip

FIG. 6 is a comparison of Pt ball growths and MWNT with 10 kV 3.8 pA, 20 kV 25 pA and 30 kV 7.8 pA ion beams (a) Growth of the ball/tube diameter ratio (y/x), (b) tube diameter (x) growth with 10 kV, 20 kV and 30 kV ion beam and (c) ball diameter (y) growth comparisons

### EXPLANATION OF REFERENCE NUMERALS FOR MAIN PORTIONS IN DRAWINGS

10: spheroid deposit 20: nanoneedle

30: mother tip x: diameter of the nanoneedle

y: diameter of the spheroid deposit 100: SPM nanoprobe

### BEST MODE FOR CARRYING OUT THE INVENTION

Hereinafter, the present invention will be described in more detail through preferred embodiments of the present invention. However, the follow embodiments are provided to aid understanding of the present invention, the present invention is not limited only to the follow embodiments.

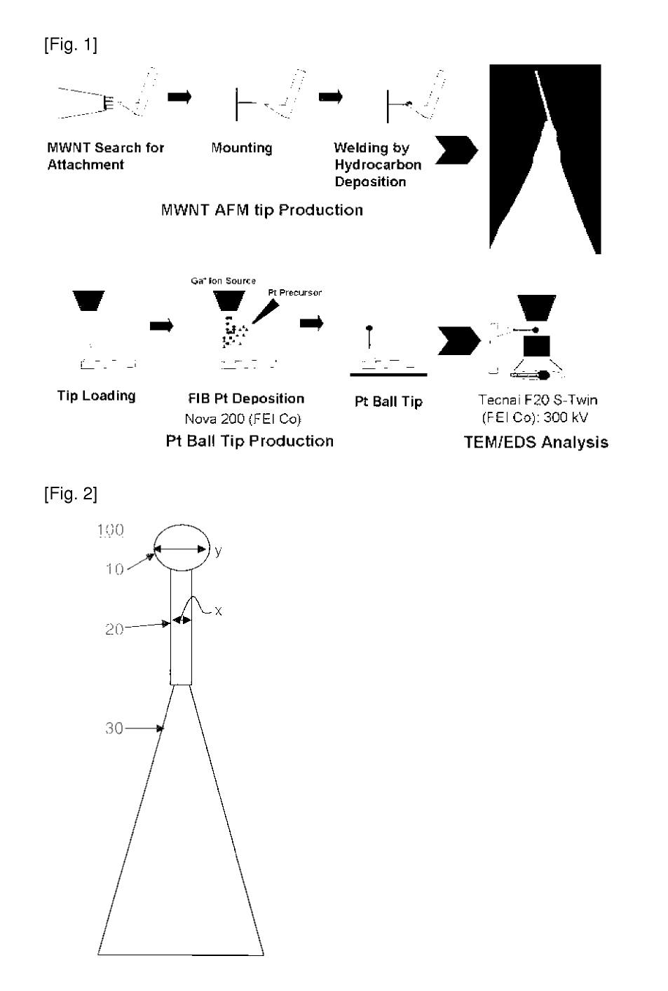

FIG. 1 is a illustration for preparation process of SPM nanoprobe of the present invention and FIG. 2 is illustrative cross sectional view of SPM nanoprobe of the present invention. As shown in FIGS. 1 and 2, the SPM nanoprobe of the present invention is a probe that a nanoneedle is bonded to an end portion of a mother tip. And also, as shown in FIG. 2 and Korean Patent No. 767994, a bonding of a nanoneedle to a mother tip may be performed by welding of a hydrocarbon deposition.

Hereinafter, the “nanoneedle” means a fine structure having the diameter or length of 0.1 to 1,000 nm, including nanotube and nanowire. When the nanoneedle is nanotube, nanotube may be single-wall nanotube, double-wall nanotube or malti-wall nanotube (MWNT). In the embodiment of the present invention, malti-wall carbon nanotube (MWNT) is used as a nanoneedle.

A SPM nanoprobe (100) according to the present invention comprises a spheroid deposit (10) capped-nanoneedle (20) bonded to one end of a mother tip (30), wherein the spheroid deposit (10) is formed by particle beam induced deposition and is characterized in that the ratio of the diameter of the spheroid deposit to that of the nanoneedle is in the range of 1.5 to 8.5. Conventionally, a particle beam, especially focused ion beam is used in micromachining like milling, etching and deposition. The present inventors have found that the shape and size control of a deposit is possible when the acceleration voltage and particle density of focused ion beam is regulated. Especially, in case the particle beam is radiated at the end portion of a nanoneedle, the deposit is deposited at entire nanoneedle body including end portion, and the growth rate of spherical deposit formed at the end portion of nanoneedle is greater than that of nanoneedle body under the specified condition. In the present invention, when the particle beam acceleration voltage is in the range of 5 to 50 KeV and particle density is in the range of 400 to 10,000 particle/nm2, the diameter of spheroid deposit and the ratio (y/x) of the diameter of the spheroid deposit (y) to that of the nanoneedle (x) can be controlled in the range of 15 to 1,000 nm and in the range of 1.5 to 8.5, respectively.

It is preferable that the diameter of spheroid deposit is in the range of 15 to 1,000 nm, and the ratio (y/x) of the diameter of the spheroid deposit (y) to that of the nanoneedle (x) is controlled in the range of 1.5 to 8.5. If the diameter of spheroid deposit or ratio (y/x) is below 15 nm or 1.5, the object of the present invention cannot be achieved. While the diameter of spheroid deposit or ratio (y/x) is larger than 15 nm or 8.5, it is hard to maintain the spheroid shape of deposit. Considering the use of the deposit, is is preferable that the deposit maintains sphere or oblate shape. Therefore, it is more preferable that the diameter of spheroid deposit is in the range of 80 to 600 nm, and the ratio (y/x) of the diameter of the spheroid deposit (y) to that of the nanoneedle (x) is controlled in the range of 2 to 8.

The deposit material of the present invention is not especially limited and can be all material generally known as preferable in particle beam induced deposition. Considering the SPM nanoprobe is used as CD-SPM probe, it is preferable that the spheroid deposit is made of electrically conductive material like metal, carbon or the mixture thereof. In embodiment of the present invention, precursor gas used was methylcyclopentadienyl (trimethyl) platinum (C₉H₁₆Pt).

The particle beam can be at least one selected from the group consisting of electron beam, neutron beam, proton beam, neutral atom beam and ion beam, and the neutral atom or ion can be at least one atom or ion selected from the group consisting of He, B, Ne, Mg, Al, Si, P, Cl, Ar, Ti, Cr, Ga, Ge, Kr, In, Xe, Au and Pt. It is preferable that particle beam is the ion beam or neutron beam. More preferably, the ion beam is focused ion beam, and the ion is at least one selected from the group consisting of Ga, Au, Ar, Li, Be, He and Au—Si—Be ion. It is preferable that the focused ion beam is adjusted in the range of 5 to 50 keV ion acceleration voltage, 1 pA to 1 nA and 1 to 10 seconds exposure time.

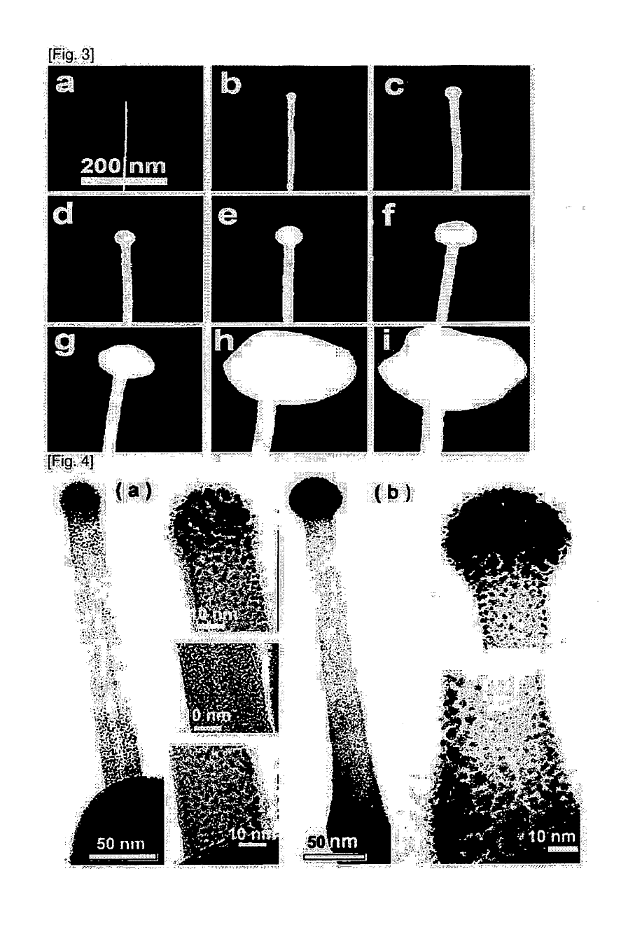

The SPM nanoprobe of the present invention can be prepared by the method comprising the steps of; D. bonding a nanoneedle to the end portion of a mother tip, D. positioning said nanoneedle bonded-mother tip in a chamber, D. forming a spheroid deposit at the end portion of the nanoneedle by radiating particle beam to the end portion of the nanoneedle under the condition of the particle acceleration voltage in the range of 5 to 50 KeV and the particle density in the range of 400 to 10,000 particle/nm², wherein the the ratio (y/x) of the diameter of the spheroid deposit (y) to that of the nanoneedle (x) is in the range of 1.5 to 8.5. FIG. 3 is SEM images of Pt ball growth at the free-end of MWNT tip. After MWNT tip was aligned by ion beam (a). Pt was deposited in steps with the cumulative target thicknesses: (b) 20 nm, (c) 30 nm, (d) 40 nm, (e) 60 nm, (f) 120 nm, (g) 190 nm, (h) 340 nm, and (i) 400 nm. As shown in FIG. 3, the SPM nanoprobe according to the present invention can be manufactured with the diameter of spheroid deposit and the ratio (y/x) of the diameter of the spheroid deposit (y) to that of the nanoneedle arbitrarily controlled.

MWNT tips were produced by attaching MWNTs on AFM tips using e-beam induced deposition (EBID) of hydrocarbon in a scanning electron microscope (SEM). In this method, MWNT cartridge is located on one side and a mother AFM tip is loaded to the other side of a nanomanipulator in SEM. Precisely controlled movement of two sides locates the target MWNT to the apex of AFM tip under SEM observation. And EBID of hydrocarbon attaches MWNT to AFM tip. A SEM image of an MWNT tip after production is shown in FIG. 1. After MWNT tip production, we used an ion beam induced deposition (IBID) of Pt in a dual-beam focused ion-beam (FIB) machine (Nova 200, FEI, Co.) to deposit Pt on MWNT tips. The precursor gas used was methylcyclopentadienyl (trimethyl) platinum (C₉H₁₆Pt). Before Pt deposition, MWNT was aligned toward Ga+ ion beam using the ion beam bending phenomenon. During Pt deposition a gas injection system puts enhanced flux of precursor gas onto the sample surface and saturates the target surface with adsorbed precursor. And Pt is deposited by ion energy induced breakings of the adsorbed precursor. Ion beam acceleration voltages used were 10, 20, and 30 kV, and nominal ion beam currents used were 3, 10, and 23 pA. We measured the actual ion beam currents using a Faraday cup. They were up to 30% off the nominal value. it deposition was done in steps with target thicknesses varying from 10 to 200 nm. The experimental conditions including ion beam acceleration voltages, current and flux are described in Table 1.

TABLE 1

| | | Actual | Actual Ga Ion |
|---|---|---|---|
| Acceleration | Nominal Current | Current | Fluence per 10 nm |
| Voltage [kV] | [pA] | [pA] | target thickness [ion/nm³] |
| 10 | 3.0 | 3.8 | 180 |
| 20 | 23 | 25 | 160 |
| 30 | 10 | 7.8 | 99 |

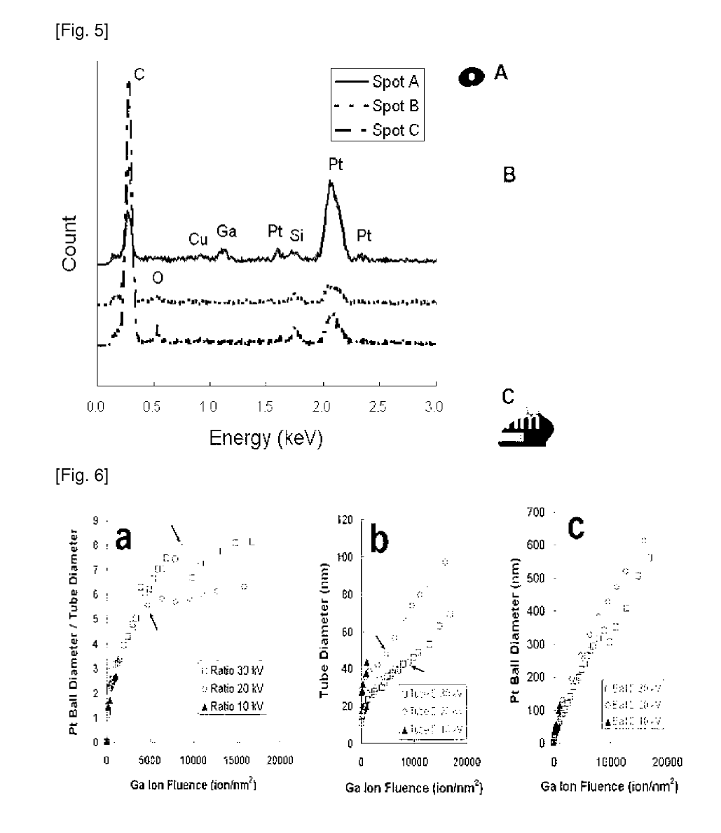

FIG. 4 is TEM images of Pt ball tips and FIG. 5 is EDS results at various spots on a Pt ball tip. As shown in FIGS. 4 and 5, the major elements forming the deposit are carbon and platinum, and the platinum contents of spheroid deposit (Spot A) is higher than that of nanoneedle body.

FIG. 6 is a comparison of Pt ball growths and MWNT with 10 kV 3.8 pA, 20 kV 25 pA and 30 kV 7.8 pA ion beams (a) Growth of the ball/tube diameter ratio (y/x), (b) tube diameter (x) growth with 10 kV, 20 kV and 30 kV ion beam and (c) ball diameter (y) growth comparisons. As shown in FIG. 6, the diameter of the spheroid deposit (y) and the ratio (y/x) of the diameter of the spheroid deposit (y) to that of the nanoneedle (x) is increased as the particle acceleration voltage elevate, and the ratio (y/x) is increased as the ion current is increased.

### INDUSTRIAL APPLICABILITY

As described above, the present invention provides a SPM nanoprobe comprising a spheroid deposit capped-nanoneedle bonded to one end of a mother tip, wherein the spheroid deposit is formed by particle beam induced deposition and is characterized in that the ratio of the diameter of the spheroid deposit to that of the nanoneedle is in the range of 1.5 to 8.5, which is capable of imaging or measuring a irregularly curved or complicated surface, pattern and/or a frictional or adhesive force thereof and controlling size of a spheroid deposit formed at the end portion of nanoneedle and the ratio of the diameter of the spheroid deposit to that of the nanoneedle arbitrarily.

It is intended that the embodiments of the present invention described above should not be construed as limiting the technical spirit of the present invention. The scope of the present invention is defined only by the appended claims. Those skilled in the art can make various changes and modifications thereto without departing from the spirit. Therefore, various changes and modifications obvious to those skilled in the art will fall within the scope oldie present invention.

1. A SPM nanoprobe comprising a spheroid deposit capped-nanoneedle bonded to one end of a mother tip, wherein the spheroid deposit is formed by particle beam induced deposition and is characterized in that the ratio (y/x) of the diameter of the spheroid deposit (y) to that of the nanoneedle (x) is in the range of 1.5 to 8.5.

2. The SPM nanoprobe as in claim 1, wherein the diameter of spheroid deposit is in the range of 15 to 1,000 nm.

3. The SPM nanoprobe as in claim 1, wherein the particle beam induced deposition is performed under the condition of the particle acceleration voltage in the range of 5 to 50 KeV and the particle density is in the range of 400 to 10,000 particle/nm².

4. The SPM nanoprobe as in claim 1, wherein the particle beam is at least one selected from the group consisting of electron beam, neutron beam, proton beam, neutral atom beam and ion beam.

5. The SPM nanoprobe as in claim 4, wherein the neutral atom or ion is at least one atom or ion selected from the group consisting of He, B, Ne, Mg, Al, Si, P, Cl, Ar, Ti, Cr, Ga, Ge, Kr, In, Xe, Au and Pt.

6. The SPM nanoprobe as in claim 1, wherein the spheroid deposit is made of metal, carbon or the mixture thereof.

7. The SPM nanoprobe as in claim 2, wherein the ratio (y/x) of the diameter of the spheroid deposit (y) to that of the nanoneedle (x) is in the range of 2 to 8, and the diameter of spheroid deposit is in the range of 80 to 600 nm.

8. A preparation method for SPM nanoprobe comprising:
i. bonding a nanoneedle to the end portion of a mother tip,
ii. positioning said nanoneedle bonded-mother tip in a chamber,
iii. forming a spheroid deposit at the end portion of the nanoneedle by radiating particle beam to the end portion of the nanoneedle under the condition of the particle acceleration voltage in the range of 5 to 50 KeV and the particle density in the range of 400 to 10,000 particle/nm², wherein the ratio (y/x) of the diameter of the spheroid deposit (y) to that of the nanoneedle (x) is in the range of 1.5 to 8.5.

9. The preparation method for SPM nanoprobe as in claim 8, wherein the diameter of spheroid deposit is in the range of 15 to 1,000 nm.

10. The preparation method for SPM nanoprobe as in claim 8, wherein the particle beam is at least one selected from the group consisting of electron beam, neutron beam, proton beam, neutral atom beam and ion beam.

11. The preparation method for SPM nanoprobe as in claim 10, wherein the neutral atom or ion is at least one atom or ion selected from the group consisting of He, B, Ne, Mg, Al, Si, P, Cl, Ar, Ti, Cr, Ga, Ge, Kr, In, Xe, Au and Pt.

12. The preparation method for SPM nanoprobe as in claim 8, wherein the spheroid deposit is made of metal, carbon or the mixture thereof.

13. The preparation method for SPM nanoprobe as in claim 8, wherein the ratio (y/x) of the diameter of the spheroid deposit (y) to that of the nanoneedle (x) is in the range of 2 to 8, and the diameter of spheroid deposit is in the range of 80 to 600 nm.
